(19) United States
(12) Patent Application Publication
(10) Pub. No.: US 2025/0124910 A1
(43) Pub. Date: Apr. 17, 2025

(54) SOUND MASKING APPARATUS AND METHOD THEREOF

(71) Applicants: HYUNDAI MOTOR COMPANY, Seoul (KR); KIA CORPORATION, Seoul (KR)

(72) Inventor: Kyoung Jin Chang, Suwon-si (KR)

(73) Assignees: HYUNDAI MOTOR COMPANY, Seoul (KR); KIA CORPORATION, Seoul (KR)

(21) Appl. No.: 18/733,484

(22) Filed: Jun. 4, 2024

(30) Foreign Application Priority Data
Oct. 16, 2023 (KR) 10-2023-0137804

(51) Int. Cl. G10K 11/175; G06V 20/59; G06V 40/16

(52) U.S. Cl. CPC G10K 11/1754; G06V 20/593; G06V 40/176

(57) ABSTRACT

A sound masking apparatus and method mask conversation noise in a vehicle. The sound masking apparatus includes a microphone in a vehicle and a processor connected to the microphone. The processor may detect conversation noise using the microphone, may modulate the conversation noise to generate a masking sound source, and may mask the conversation noise by playing the masking sound source.

### CROSS-REFERENCE TO RELATED APPLICATION

This application claims the benefit of and priority to Korean Patent Application No. 10-2023-0137804, filed in the Korean Intellectual Property Office on Oct. 16, 2023, the entire contents of which are incorporated herein by reference.

### TECHNICAL FIELD

The present disclosure relates to a sound masking apparatus for masking conversation noise in a vehicle and a method thereof.

### BACKGROUND

A noise masking technology is a technology for measuring ambient noise and generating a waveform to mask the noise. Existing noise masking technology changes the frequency and sound pressure of a sound configured with a sine wave, links and plays a previously input sample voice with a parameter according to the noise, or plays a random characteristic noise, e.g., white noise or pink noise.

Such existing noise masking technology generates side effects that cause a masking effect to be low or ineffective. Additionally, such existing noise masking technology causes hearing discomfort due to a difference in frequency characteristic between a noise source and a masking sound source, a difference in volume between the noise source and the masking sound source, and the like.

### SUMMARY

The present disclosure has been made to solve the above-mentioned problems occurring in the prior art while advantages achieved by the prior art are maintained intact.

Aspects of the present disclosure provide a sound masking apparatus and method for measuring conversation noise generated in a vehicle and generating a masking sound source using the measured conversation noise.

Other aspects of the present disclosure provide a sound masking apparatus and method for masking conversation noise currently generated in a vehicle using a masking sound source based on conversation noise.

The technical problems to be solved by the present disclosure are not limited to the aforementioned problems. Any other technical problems not mentioned herein should be more clearly understood from the following description by those of ordinary skill in the art to which the present disclosure pertains.

According to an aspect of the present disclosure, a sound masking apparatus may include a microphone in a vehicle and a processor connected to the microphone. The processor may be configured to detect conversation noise using the microphone, modulate the conversation noise to generate a masking sound source, and mask the conversation noise by playing the masking sound source.

The processor may be configured to determine whether a sound pressure level of a sound detected by the microphone is greater than a predetermined reference level and continues for a predetermined reference time or more. The processor may also be configured to determine that noise is generated, when it is determined that the sound pressure level of the detected sound is greater than the predetermined reference level and continues for the predetermined reference time or more. The processor may also be configured to extract a frequency characteristic from the detected sound and to determine whether noise generated based on the extracted frequency characteristic is conversational noise.

The processor may be configured to extract a Mel-frequency cepstral coefficient (MFCC) from the detected sound by a short-time fast Fourier transform (FFT) analysis and convert the extracted MFCC into a noise spectrum.

The processor may be configured to modulate the conversation noise in a reverse playback scheme to generate the masking sound source.

The processor may be configured to modulate the conversation noise in a reordering scheme to generate the masking sound source.

The processor may be configured to modulate the conversation noise in a reverse playback scheme, modulate the conversation noise in a reordering scheme, and overlap the conversation noise modulated in the reverse playback scheme with the conversation noise modulated in the reordering scheme to generate the masking sound source.

The processor may be configured to adjust a volume of the masking sound source with regard to a level of the conversation noise.

The processor may be configured to capture an image of a passenger using a camera and may determine a position where the conversation noise is generated, based on at least one of a mouth shape of the passenger in the captured image, whether the passenger uses a portable terminal, or any combination thereof.

The processor may be configured to detect a sound using a microphone for each seat and determine a position where the conversation noise is generated, based on a level of the sound detected by the microphone for each seat.

The processor may be configured to determine at least one speaker to output the masking sound source among a plurality of speakers mounted in the vehicle based on a position where the conversation noise is generated.

According to another aspect of the present disclosure, a sound masking method may include detecting conversation noise generated in a vehicle using a microphone and may include modulating the conversation noise to generate a masking sound source. The method may also include masking the conversation noise by playing the masking sound source.

Detecting the conversation noise may include determining whether a sound pressure level of a sound detected by the microphone is greater than a predetermined reference level and continues for a predetermined reference time or more. Detecting the conversation noise may also include determining that noise is generated, when it is determined that the sound pressure level of the detected sound is greater than the predetermined reference level and continues for the predetermined reference time or more. Detecting the conversation noise may also include extracting a frequency characteristic of the detected sound and determining whether noise generated based on the extracted frequency characteristic is conversational noise.

Extracting the frequency characteristic may include extracting a Mel-frequency cepstral coefficient (MFCC) from the detected sound by a short-time FFT analysis and converting the extracted MFCC into a noise spectrum.

Generating the masking sound source may include modulating the conversation noise in a reverse playback scheme to generate the masking sound source.

Generating the masking sound source include modulating the conversation noise in a reordering scheme to generate the masking sound source.

Generating the masking sound source may include modulating the conversation noise in a reverse playback scheme and may include modulating the conversation noise in a reordering scheme. Generating the masking sound source may also include overlapping the conversation noise modulated in the reverse playback scheme with the conversation noise modulated in the reordering scheme to generate the masking sound source.

Masking the conversation noise may include adjusting a volume of the masking sound source with regard to a level of the conversation noise.

Masking the conversation noise may include capturing an image of a passenger using a camera and determining a position where the conversation noise is generated, based on at least one of a mouth shape of the passenger in the captured image, whether the passenger uses a portable terminal, or any combination thereof.

Masking the conversation noise may include detecting a sound using a microphone for each seat and determining a position where the conversation noise is generated, based on a level of the sound detected by the microphone for each seat.

Masking the conversation noise may include determining at least one speaker to output the masking sound source among a plurality of speakers mounted in the vehicle based on a position where the conversation noise is generated.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating a configuration of a sound masking apparatus according to embodiments of the present disclosure;

FIG. 2 is a flowchart illustrating a sound masking method according to embodiments of the present disclosure;

FIG. 3 is a graph for describing a method of determining whether noise is generated according to embodiments of the present disclosure;

FIG. 4 is a diagram for describing a method for analyzing noise according to embodiments of the present disclosure;

FIG. 5 is a diagram for describing a method of determining a noise type according to embodiments of the present disclosure;

FIG. 6 is a diagram for describing a method for modulating a sound source according to embodiments of the present disclosure;

FIG. 7 is a diagram for describing a method for adjusting volume according to embodiments of the present disclosure;

FIGS. 8 and 9 are diagrams for describing a method for determining a speaker channel according to embodiments of the present disclosure;

FIG. 10 includes graphs for describing a process of synthesizing a masking sound source according to embodiments of the present disclosure;

FIG. 11 illustrates a frequency spectrum of synthesized conversation noise, a masking sound source, and masked conversation noise according to embodiments of the present disclosure; and

FIG. 12 is a table of evaluation results for describing an action effect according to embodiments of the present disclosure.

### DETAILED DESCRIPTION

Hereinafter, embodiments of the present disclosure are described in detail with reference to the drawings. In adding the reference numerals to the components of each drawing, it should be noted that identical components are designated by the identical reference numerals even when they are displayed on different drawings. In addition, a detailed description of well-known features or functions has been omitted in order not to unnecessarily obscure the gist of the present disclosure.

In describing components of the embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those having ordinary skill in the art to which the present disclosure pertains. Such terms as those defined in a generally used dictionary are to be interpreted as having meanings consistent with the contextual meanings in the relevant field of art. Such terms are not to be interpreted as having ideal or excessively formal meanings unless clearly defined as having such in the present application.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

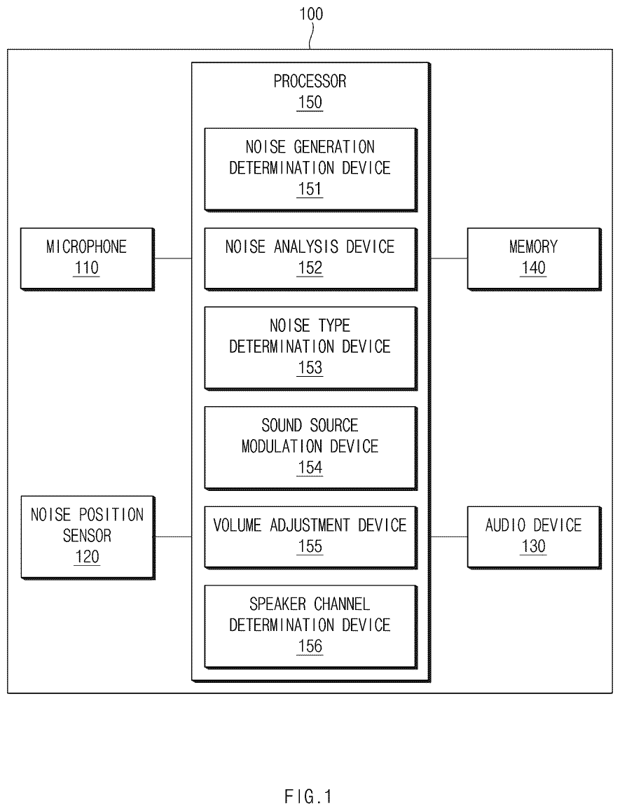

FIG. 1 is a block diagram illustrating a configuration of a sound masking apparatus according to embodiments of the present disclosure.

Referring to FIG. 1, a sound masking apparatus 100 may include a microphone 110, a noise position sensor 120, an audio device 130, a memory 140, and a processor 150.

The microphone 110 may be loaded into (i.e., mounted in/on) a vehicle to detect a sound generated in the vehicle. In other words, the microphone 110 may measure noise generated in the vehicle, e.g., conversation noise or the like. The one microphone 110 is shown in FIG. 1, but not limited thereto. Two or more microphones may be loaded at different positions in the vehicle. For example, the two or more microphones may be embedded around respective seats.

The noise position sensor 120 may sense a position where noise is generated, i.e., a noise position, using a camera and/or the microphone 110. As an example, the noise position sensor 120 may capture an image of a passenger (e.g., a driver, another passenger, and/or the like) using the camera. The noise position sensor 120 may analyze a mouth shape of the passenger, whether the passenger uses a portable terminal (e.g., a mobile device, a cell phone, a smartphone, or the like), and/or the like from the captured passenger image to determine whether the passenger is having a conversation. When it is determined that the passenger is having a conversation, the noise position sensor 120 may determine a seat position at which the passenger sits as a noise position. As another example, the noise position sensor 120 may determine whether a passenger sitting in each seat is making an utterance using the microphone 110 embedded near each seat. When it is determined that the passenger is making the utterance, the noise position sensor 120 may determine a seat position at which the passenger sits as a noise position (or a conversation noise generation position).

The audio device 130 may play a masking sound source under an instruction of the processor 150. The audio device 130 may output the played masking sound source through an amplifier, a speaker, and/or the like. The audio device 130 may transmit an audio signal of the played masking sound source to at least one specified speaker among a plurality of speakers mounted in the vehicle. The speaker to output the audio signal of the masking sound source may be selected by the processor 150.

The memory 140 may be a non-transitory storage medium that stores instructions executed by the processor 150 and that may transmit and receive data with the processor 150 through various well-known means. The memory 140 may include a flash memory, a hard disk, a solid state disk (SSD), a secure digital (SD) card, a random access memory (RAM), a static RAM (SRAM), a read only memory (ROM), a programmable ROM (PROM), an electrically erasable and programmable ROM (EEPROM), an erasable and programmable ROM (EPROM), and/or the like.

The processor 150 may control the overall operation of the sound masking apparatus 100. The processor 150 may include an application specific integrated circuit (ASIC), a digital signal processor (DSP), programmable logic devices (PLD), field programmable gate arrays (FPGAs), a central processing unit (CPU), microcontrollers, microprocessors, and/or the like.

The processor 150 may be connected to the microphone 110, the noise position sensor 120, the audio device 130, and the memory 140 over a vehicle network. The vehicle network may include a controller area network (CAN), a media-oriented systems transport (MOST) network, a local interconnect network (LIN), an Ethernet, X-by-Wire (Flexray), and/or the like.

The processor 150 may include a noise generation determination device 151, a noise analysis device 152, a noise type determination device 153, a sound source modulation device 154, a volume adjustment device 155, and a speaker channel determination device 156. Each of the noise generation determination device 151, the noise analysis device 152, the noise type determination device 153, the sound source modulation device 154, the volume adjustment device 155, and the speaker channel determination device 156 may be implemented as hardware or software. The software may be stored in the memory 140 and may be executed by the processor 150.

The noise generation determination device 151 may analyze the sound received from the microphone 110 to determine whether noise is generated. The noise generation determination device 151 may determine whether the sound pressure level of the sound received by the microphone 110 is greater than a predetermined reference level and continues for a predetermined reference time or more. In other words, the noise generation determination device 151 may determine whether the received sound meets Equation 1 below and may determine whether noise is generated based on the determined result.

$${\sum }_{i = 1}^{{N}_{count}} True ( {Level}_{bandpass} ( i ) > {Level}_{s} ) > {C}_{ref} \qquad [ Equation l ]$$

In detail, the noise generation determination device 151 may repeatedly determine whether noise is generated a predetermined number of times N_{count} at intervals of a predetermined unit time (e.g., 0.5). The noise generation determination device 151 may apply a band pass filter of a voice concentration frequency band (e.g., 500 Hz to 5000 Hz) to a sound measured in real time for an ith unit time (or an i^{th} period). The noise generation determination device 151 may extract a sound of the voice concentration frequency band from the sound measured by applying the band pass filter. The noise generation determination device 151 may calculate an average sound pressure level (or a root mean square (RMS) level) Level_{bandpass}(i) of the extracted sound of the voice concentration frequency band. The noise generation determination device 151 may compare the calculated average sound pressure level Level_{bandpass}(i) of the sound with a predetermined reference level Levelₛ. When the average sound pressure level Level_{bandpass}(i) of the sound is greater than the predetermined reference level Levelₛ, the noise generation determination device 151 may determine that noise is generated (or “1”). When the average sound pressure level Level_{bandpass}(i) of the sound is less than or equal to the predetermined reference level Levelₛ, the noise generation determination device 151 may determine that noise is not generated (or “0”). The noise generation determination device 151 may count the number of times that the noise is generated, i.e., a noise generation number of times. The noise generation determination device 151 may determine whether the counted noise generation number of times is greater than a predetermined reference number of times C_{ref}. When the counted noise generation number of times is greater than the predetermined reference number of times Cᵣₑᵣ, the noise generation determination device 151 may finally determine that noise is generated. When the counted noise generation number of times is less than or equal to the predetermined reference number of times Cᵣₑᵣ, the noise generation determination device 151 may finally determine that noise is not generated.

When it is determined that the noise is generated by the noise generation determination device 151, the noise analysis device 152 may extract a frequency feature of the sound received from the microphone 110 (or the measured noise). The noise analysis device 152 may perform a short-time fast Fourier transform (FFT) analysis of the measured noise. The noise analysis device 152 may extract a Mel-frequency cepstral coefficient (MFCC) indicating a noise characteristic for each frequency from the noise measured by the short-time FFT analysis. The noise analysis device 152 may convert the extracted MFCC into a noise spectrum (e.g., a Mel-spectrogram). The extracted noise spectrum may be used as input data for a deep learning model which is described below.

The noise type determination device 153 may classify a noise type based on the extracted frequency characteristic of the noise. The noise type determination device 153 may determine a current noise type using the deep learning model which previously learns a noise frequency characteristic. A system developer may prepare a noise spectrum for each noise type as data for supervised learning to generate a deep learning model (or an artificial intelligence (AI) model) for predicting a noise type from the noise spectrum and may train the deep learning model using the data for supervised learning.

The noise type determination device 153 may classify a noise type from the noise spectrum output from the noise analysis device 152 using the deep learning model. In other words, when the noise type determination device 153 inputs the noise spectrum output from the noise analysis device 152 to the deep learning model, the deep learning model may analyze the noise spectrum and may determine and output the noise type. The noise type determination device 153 may determine whether noise measured based on the noise type output from the deep learning model is conversational noise.

When it is determined that the noise measured by the noise type determination device 153 is the conversational noise, the sound source modulation device 154 may generate a masking sound source using the measured noise. The sound source modulation device 154 may modulate the measured noise using a modulation scheme, such as reverse playback, reordering, or overlapping, thus generating a masking sound source.

The volume adjustment device 155 may adjust the volume of the masking sound source based on a magnitude of the conversational noise which is currently being generated. The volume adjustment device 155 may calculate a noise level and may determine the volume of the masking sound source as volume determined according to the calculated level. The volume adjustment device 155 may repeat volume adjustment at a predetermined period.

The speaker channel determination device 156 may determine a speaker channel to output the masking sound source based on the noise position sensed by the noise position sensor 120.

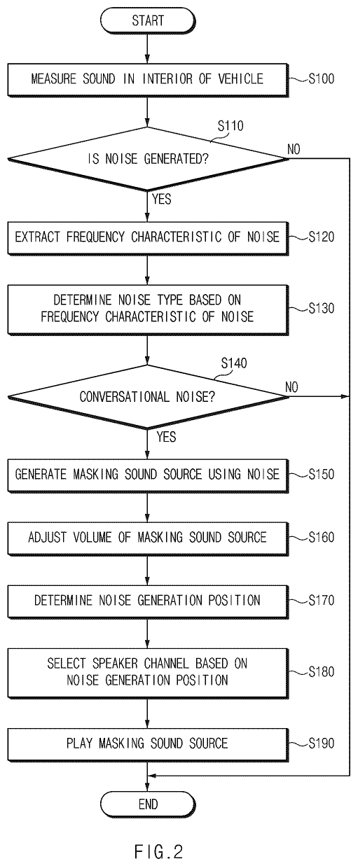

FIG. 2 is a flowchart illustrating a sound masking method according to embodiments of the present disclosure.

Referring to FIG. 2, in S100, a processor 150 of a sound masking apparatus 100 may measure a sound generated in the interior of a vehicle using a microphone 110. The at least one microphone 110 may be loaded into the vehicle. The at least one microphone 110 may detect a sound generated in the interior of the vehicle and may transmit the detected sound to the processor 150. The processor 150 may receive the detected sound transmitted from the microphone 110.

In S110, the processor 150 may analyze the measured sound and may determine whether noise is generated. The processor 150 may determine whether the measured sound is greater than a predetermined reference level and continues for a predetermined time or more. When the measured sound is greater than the predetermined reference level and continues for the predetermined time or more, the processor 150 may determine that noise is generated (YES in S110). When the measured sound is less than or equal to the predetermined reference level, when the measured sound is greater than the predetermined reference level, but continues for a duration less than the predetermined reference time, or when the measured sound is less than or equal to the predetermined reference level and continues for a duration less than the predetermined reference time, the processor 150 may determine that noise is not generated (NO in S110).

When it is determined that a noise is generated in S110, in S120, the processor 150 may extract a frequency characteristic of the measured noise. The processor 150 may perform a short-time FFT (SFFT) analysis of the noise measured by the microphone 110. The processor 150 may extract an MFCC indicating a noise characteristic for each frequency from the noise measured by the SFFT analysis. The processor 150 may convert the extracted MFCC into a noise spectrum.

In S130, the processor 150 may determine a noise type based on the extracted frequency characteristic of the noise. The processor 150 may analyze a frequency characteristic of currently generated noise using a deep learning model which previously learns a noise frequency characteristic and may classify a noise type based on the analyzed result.

In S140, the processor 150 may determine whether the determined noise type is conversational noise. The processor 150 may determine whether the noise type classified by the deep learning model is the conversational noise.

When the determined noise type is the conversational noise (YES in S140), in S150, the processor 150 may generate a masking sound source using the measured noise. The processor 150 may modulate the measured noise using a modulation scheme, such as reverse playback, reordering, or overlapping, thus generating a masking sound source.

In S160, the processor 150 may adjust the volume of the masking sound source based on a level of the measured noise. The processor 150 may repeat volume adjustment at a predetermined period.

In S170, the processor 150 may determine a position where the measured noise is generated using a noise position sensor 120. The noise position sensor 120 may sense a position where conversational noise is generated, using a camera and/or the microphone 110. The noise position sensor 120 may transmit the sensed noise generation position to the processor 150.

In S180, the processor 150 may select at least one speaker channel based on the noise generation position.

In S190, the processor 150 may play the masking sound source with the adjusted volume. The processor 150 may output an audio signal of the played sound source to the interior of the vehicle through the selected at least one speaker channel.

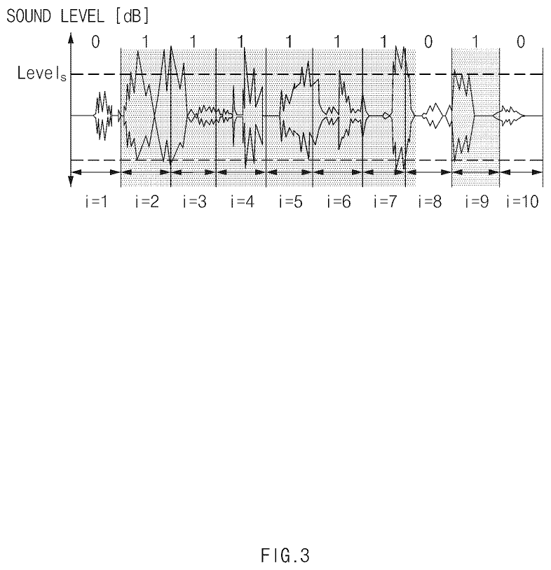

FIG. 3 is a graph describing a method of determining whether noise is generated according to embodiments of the present disclosure.

Referring to FIG. 3, a processor 150 of a sound masking apparatus 100 may measure a sound a predetermined number of times N_{count} at intervals of a predetermined unit time (or period) by a microphone 110. For example, when the predetermined number of times N_{count} is predetermined as 10 times, the processor 150 may measure a sound 10 times at intervals of a predetermined unit time, 0.5 seconds. The processor 150 may output “1”, when the average sound level of the sound measured during the unit time is greater than a predetermined reference level Levelₛ, and may output “0”, when the average sound level of the sound measured during the unit time is not greater than the predetermined reference level Levelₛ. The processor 150 may count the number of times the measured sound is greater than the predetermined reference level. The processor 150 may compare the counted number of times the measured sound is greater than the reference level with a predetermined reference number of times C_{ref}. Assuming that the predetermined reference number of times C_{ref} is 6, because the number of times the measured sound is greater than the reference level is greater than the predetermined reference number of times C_{ref} when the number of times the measured sound is greater than the reference level is 7, the processor 150 may determine that noise of the reference level or more is continuously generated.

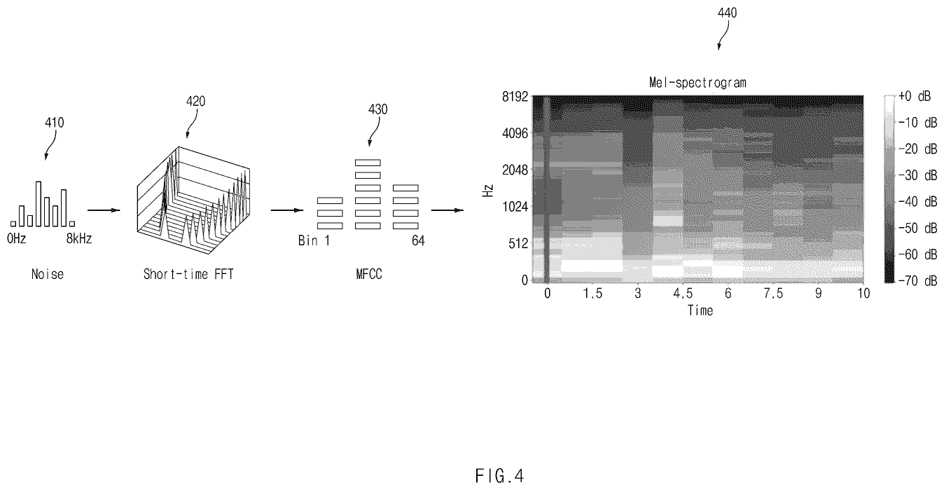

FIG. 4 is a diagram for describing a method for analyzing noise according to embodiments of the present disclosure.

Referring to FIG. 4, a processor 150 may receive a measured noise signal 410 from a microphone 110. The processor 150 may analyze the received measured noise signal 410 by short-time FFT (SFFT) 420 for repeating FFT per short time. The processor 150 may extract an MFCC 430 indicating a noise characteristic for each frequency from the noise measured by an analysis for the SFFT 420. The processor 150 may generate a Mel-spectrogram 440 using the extracted MFCC 430. At this time, the processor 150 may represent a frequency band, i.e., a y-axis as a log scale such that a frequency characteristic is better shown.

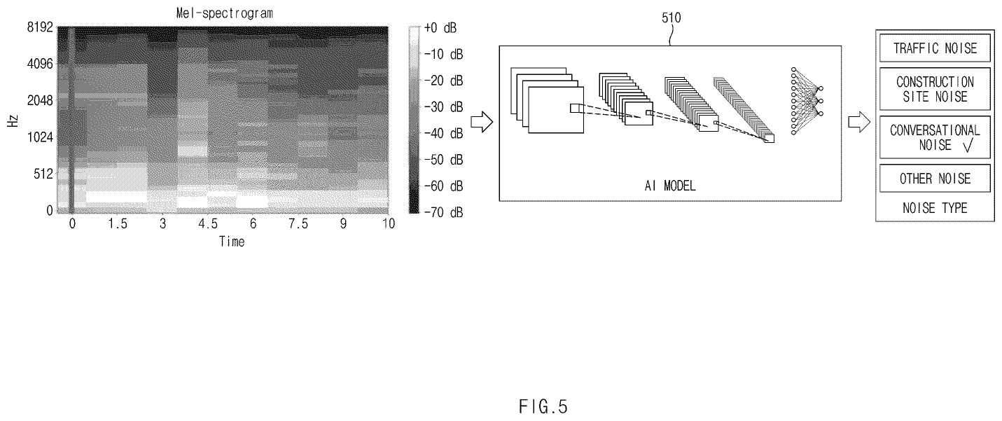

FIG. 5 is a diagram for describing a method of determining a noise type according to embodiments of the present disclosure.

A processor 150 may input a noise frequency characteristic, e.g., a Mel-spectrogram, to an AI model 510. The AI model 510 is a deep learning model for preparing a spectrum of various pieces of noise as data for supervised learning in advance and predicting a noise type generated by learning the data for supervised learning. The AI model 510 may be implemented as a convolutional neural network (CNN) algorithm, a long short-term memory (LSTM) algorithm, or the like. When using the CNN algorithm as the AI model 510, the processor 150 may input a two-dimensional (2D) image of the noise spectrum to the CNN algorithm and may classify a noise type. When using the LSTM algorithm as the AI model 510, the processor 150 may extract serial data on a frequency axis in units of a predetermined time from the noise spectrum and may input the extracted data to the LSTM algorithm to classify a noise type. The noise type may be divided into traffic noise, construction site noise, conversational noise, and other noise. The processor 150 may output the noise type classified by the AI model 510.

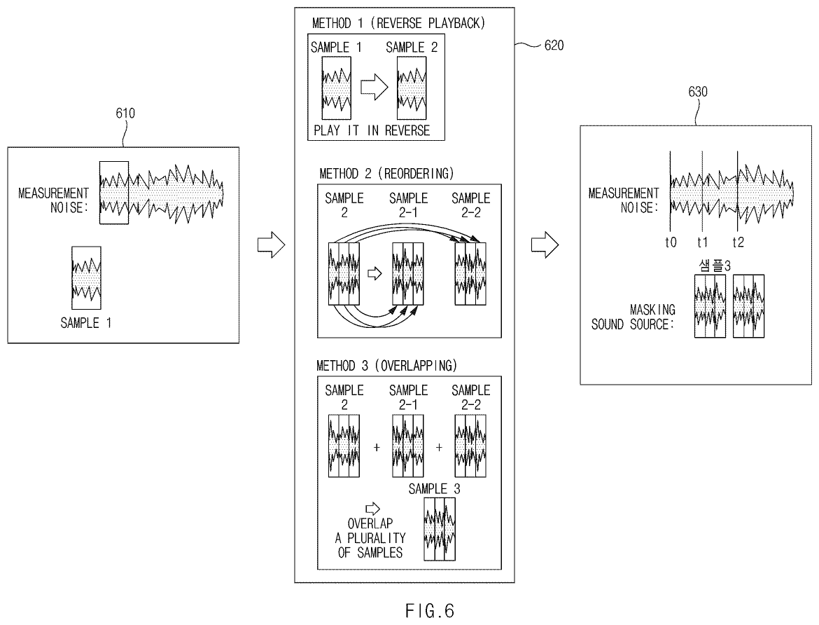

FIG. 6 is a diagram for describing a method for modulating a sound source according to embodiments of the present disclosure.

Sound source modulation may be composed of an interval separation process 610, modulation process 620, and a synchronization process 630.

First of all, in the interval separation process 610, a processor 150 may extract a portion corresponding to conversational noise (or conversation noise) at a predetermined size (e.g., about 2 to 3 seconds) from measured noise to generate a plurality of interval samples. At this time, the processor 150 may prepare a minimum of three interval samples to a dozen interval samples.

In the modulation process 620, the processor 150 may modulate the plurality of interval samples using a predetermined modulation scheme.

As an example, the processor 150 may modulate an interval sample using a reverse playback scheme. The reverse playback scheme is a scheme for simply flipping the interval sample temporally, which has the advantage of making conversation contents in a similar sound range unintelligible.

As another example, the processor 150 may modulate an interval sample using a reordering scheme. The reordering scheme is a scheme for dividing an interval sample into smaller units and randomly mixing them, which has the advantage of mixing a portion without a speech sound with a portion with a speech sound. At this time, the processor 150 may divide the interval sample into 3 to 10 interval samples. The processor 150 may use a fade-in and fade-out filter such that there is no feeling of disconnection when connecting the divided interval samples.

As another example, the processor 150 may modulate an interval sample using an overlapping scheme. The overlapping scheme is a scheme for overlapping all of the interval samples modulated by the reverse playback scheme and the reordering scheme to provide the feeling of a combination of several pieces of noise. The reason for overlapping the plurality of interval samples is because, when there is a portion in the conversation where the speech sound is interrupted, even when played in reverse or reordered, the portion may not be modulated and may remain in a noise state without conversation. Because the overlapping scheme overlaps the interval samples reordered above together, it has the advantage of preventing the portion where the speech sound is interrupted from being generated and making it more difficult to understand by combining several speech sounds. At this time, the rate at which the samples overlap with each other and the number of the samples may be selected by a user. As there are more speechless intervals, it may be advantageous to overlap a larger number of samples to reduce the speechless intervals. For example, when the current ratio of the interval with speech sound to the interval without speech sound is 1:3 in a first interval, even when it is played in reverse and is reordered, the probability of an interval without speech sound is high at 75%. Thus, reordered four samples are prepared and overlapped with each other, because the probability of an interval without speech sound approaches 0%, and the desired effect may be obtained.

In the synchronization process 630, the processor 150 may play an interval sample that is delayed by a predetermined latency and is modulated, i.e., a masking sound source to perform masking. The latency may be a minimum time advantageous to modulate an interval sample, which may be predetermined by a system designer.

For example, the processor 150 may modulate an interval sample composed of noise measured from a time t0 to a time t1 to generate a masking sound source. Additionally, the processor 150 may play the masking sound source to perform masking, after the latency elapses from the time t1. Thereafter, the processor 150 may modulate measurement noise (i.e., an interval sample) from the time t1 to a time t2 to generate a masking sound source and may play the generated masking sound source, after the latency elapses from the time t2. As such, after waiting until the latency elapses from a sample interval end time point, the processor 150 may repeat the process of playing the generated masking sound source. At this time, as the masking sound source is played after being delayed by the predetermined latency, a masking effect is interrupted during the latency. Thus, the processor 150 may separate an interval sample with regard to the latency. In other words, the processor 150 may separately modulate measurement noise from “to-latency” to the time t1 as a sample, rather than measurement noise from the time to to the time t1, thus preventing the masking effect from being interrupted.

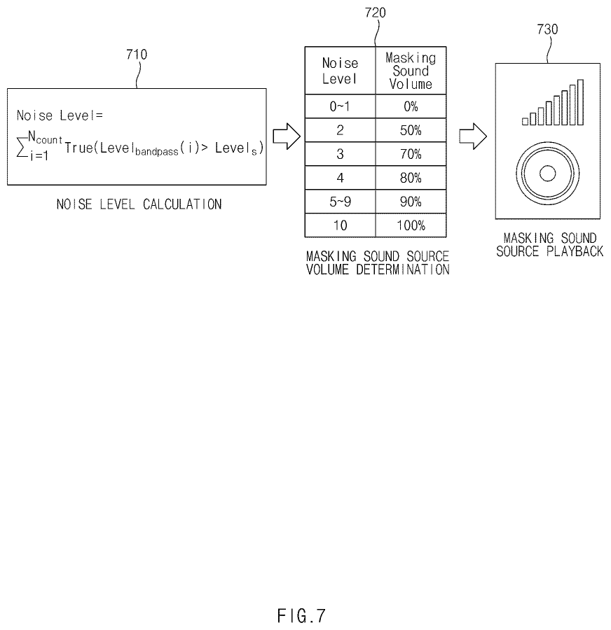

FIG. 7 is a diagram for describing a method for adjusting volume according to embodiments of the present disclosure.

Volume adjustment may be composed of a noise level calculation process 710, a masking sound source volume determination process 720, and a masking sound source playback process 730.

In the noise level calculation process 710, a processor 150 may measure noise during a predetermined certain period and may calculate a noise level of the measured noise. At this time, the processor 150 may calculate a noise level using Equation 1 above. The noise level may be defined as the number of times the generation of noise greater than a reference level is detected.

In the masking sound source volume determination process 720, the processor 150 may determine volume mapped to the noise level calculated with reference to a lookup table stored in the memory 140 as the volume of a masking sound source. The volume mapped to the noise level may be defined in the lookup table. To increase a masking effect, the noise level may be designed in the form of setting volume from “0” up to a minimum reference level (e.g., “1”) and rapidly increasing volume at a time point when the noise level is greater than the minimum reference level to gently increase the volume.

In the masking sound source playback process 730, the processor 150 may play a masking sound source with the determined volume. The processor 150 may repeat the noise level calculation process 710, the masking sound source volume determination process 720, and the masking sound source playback process 730 at a predetermined certain period (a unit time×a detection number of times). The processor 150 may optimally adjust the volume of the masking sound source to be suitable for a noise magnitude.

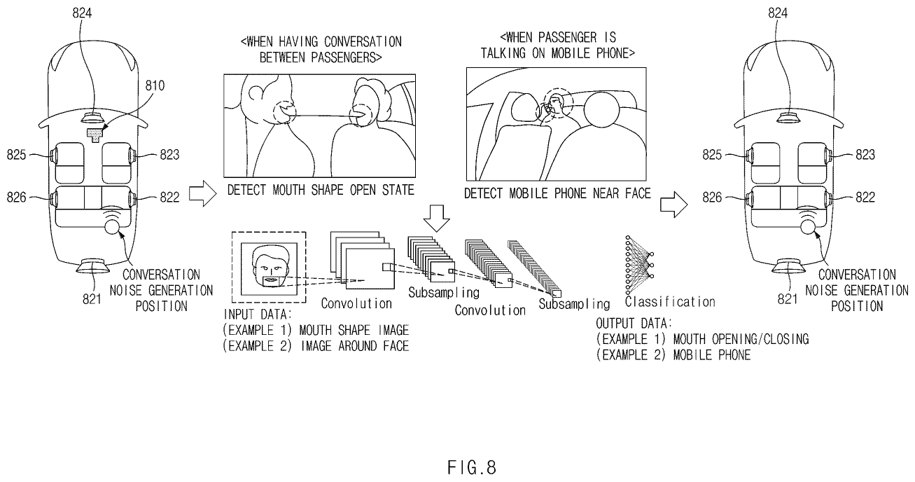

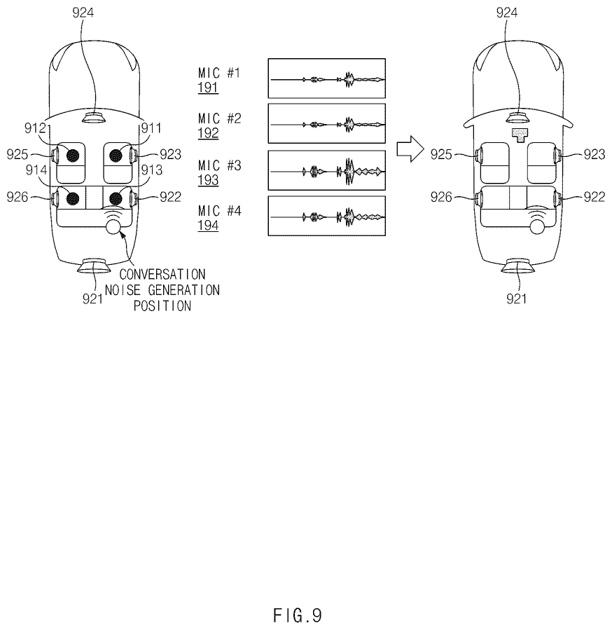

FIGS. 8 and 9 are diagrams for describing a method for determining a speaker channel according to embodiments of the present disclosure.

A processor 150 may determine a position where conversation is generated, or a smartphone phone call is generated to provide a masking effect to only the passenger(s) who do(es) not participate(s) in the conversation. Additionally, the processor 150 may select a speaker mounted near the passenger who deviates from the noise generation source to output a masking sound source.

As an example, when conversation noise is generated in the driver's seat, the processor 150 may determine a speaker channel to play and output a masking sound source through the door speakers of the remaining seats.

As another example, the processor 150 may detect a position where conversation noise is generated using a camera and/or a microphone 110, when the conversation noise is generated in a vehicle. Additionally, the processor 150 may determine a speaker channel to output a masking sound source based on the detected position where the noise is generated.

Referring to FIG. 8, when it is determined that conversational noise is generated in a vehicle, the processor 150 may capture a passenger using a camera 810. The processor 150 may analyze a mouth shape of the passenger and/or an area around the face of the passenger in the captured image. The processor 150 may determine whether the passenger has his or her mouth open and/or whether there is a portable terminal near the face of the passenger by an image analysis. The processor 150 may detect a passenger a predetermined number of times during a predetermined certain time. When it is determined that the passenger has the mouth open the reference number of times or more and/or that the passenger is talking using the portable terminal, the processor 150 may determine a position of a seat in which the passenger sits as a conversation noise generation position. When conversation is performed between two passengers in the vehicle, the processor 150 may determine that both of the positions of seats in which the two passengers sit as conversation noise generation positions.

When the conversation noise generation position is determined as the right rear seat, the processor 150 may select speakers 823 to 826 mounted near the remaining seats except for speakers 821 and 822 located around the right rear seat as speaker channels for outputting a masking sound source.

Referring to FIG. 9, when it is determined that conversational noise is generated in the vehicle, the processor 150 may detect a voice signal uttered by a passenger using a microphone 911, 912, 913, or 914 installed for each seat. The processor 150 may calculate a noise level of a voice signal detected by the microphone 911, 912, 913, or 914, i.e., conversation noise. The processor 150 may determine a conversation noise generation position based on the calculated noise level. The processor 150 may determine a seat mapped to a microphone in which conversation noise with the largest noise level is detected as a conversation noise generation position. When the noise level NL3 of the noise detected by the microphone 913 installed at the right rear seat is the largest, the processor 150 may determine the right rear seat as a conversation noise generation position. When the conversation noise generation position is determined as the right rear seat, the processor 150 may select speakers 923 to 926 mounted near the remaining seats except for speakers 921 and 922 located around the right rear seat as speaker channels for outputting a masking sound source.

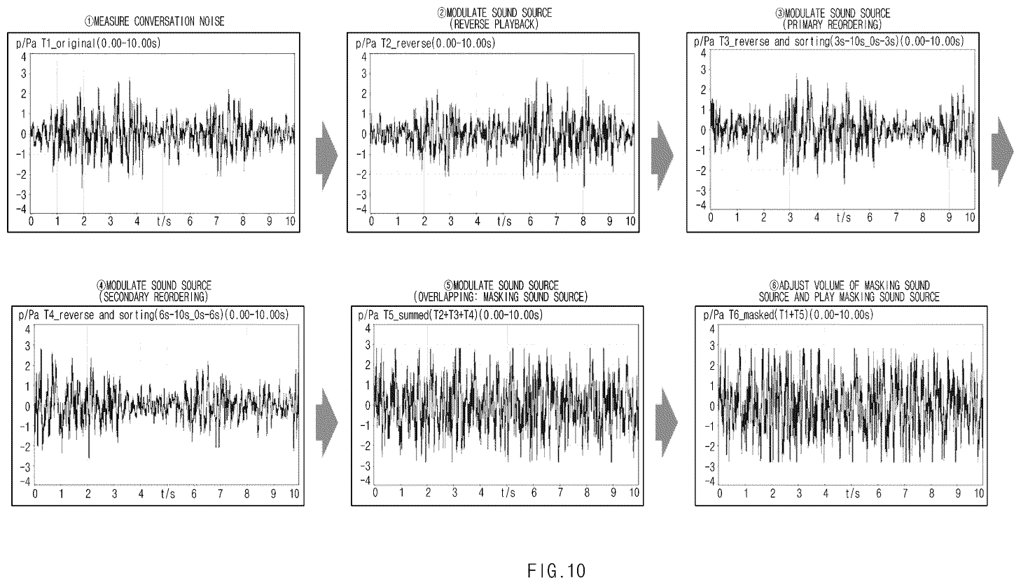

FIG. 10 includes graphs for describing a process of synthesizing a masking sound source according to embodiments of the present disclosure.

A sound masking apparatus 100 may measure noise including conversation noise for 10 seconds using a microphone 110 (\textcircled{1}). The sound masking apparatus 100 may modulate the measured noise using a reverse playback scheme (\textcircled{2}). The sound masking apparatus 100 may apply a reordering scheme to connect an interval of 0 to 3 seconds in the measured noise with an interval of 3 to 10 seconds in the measured noise (\textcircled{3}). The sound masking apparatus 100 may apply the reordering scheme to connect an interval of 0 to 6 seconds in the measured noise with an interval of 6 to 10 seconds in the measured noise (\textcircled{4}). The sound masking apparatus 100 may apply a fade-in and fade-out filter when applying the reordering scheme to connect intervals in a changed order. The sound masking apparatus 100 may overlap all of the samples modulated by applying the reverse playback scheme and the reordering scheme to generate a masking sound source (\textcircled{5}). The sound masking apparatus 100 may adjust the volume of the generated masking sound source, may play the masking sound source, and may mask currently generated conversation noise \textcircled{6}.

The sound masking apparatus 100 may generate a masking sound source that has an interval without conversation noise in the noise measured in \textcircled{1} but has no interval without conversation noise in \textcircled{5} through the modulation process in \textcircled{2} to \textcircled{4}. As such, even when the conversation is often interrupted, the sound masking apparatus 100 may modulate the conversation noise and may generate a masking sound source suitable for masking conversation noise.

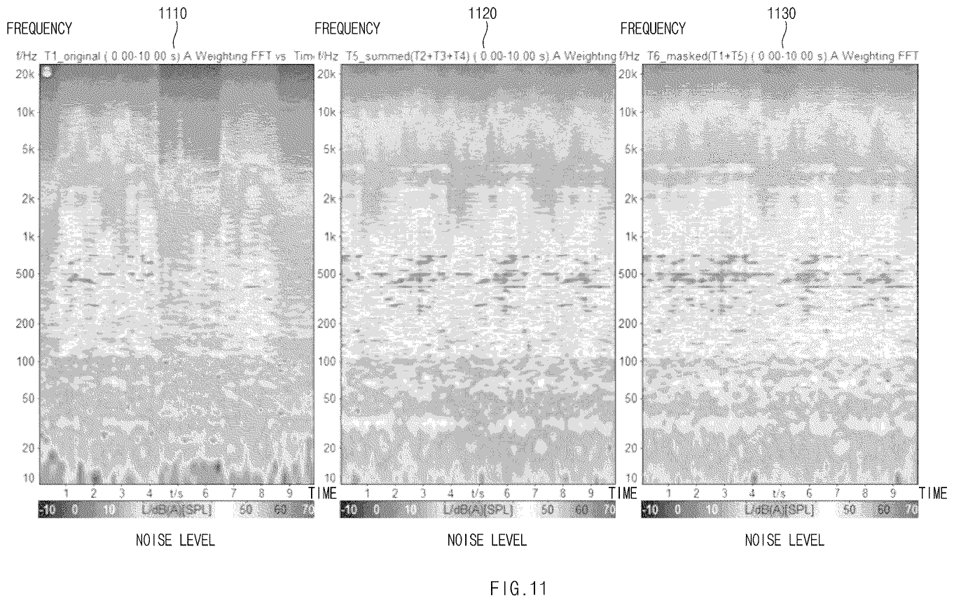

FIG. 11 illustrates a frequency spectrum of synthesized conversation noise, a masking sound source, and masked conversation noise according to embodiments of the present disclosure.

A frequency spectrum 1110 of conversation noise measured by a microphone 110 is very similar to a frequency spectrum 1120 of a masking sound source generated by modulating the measured conversation noise. Seeing a spectrum 1130 of the result of playing the generated masking sound source and masking currently generated conversation noise, it may be identified that the currently generated conversation noise is effectively masked.

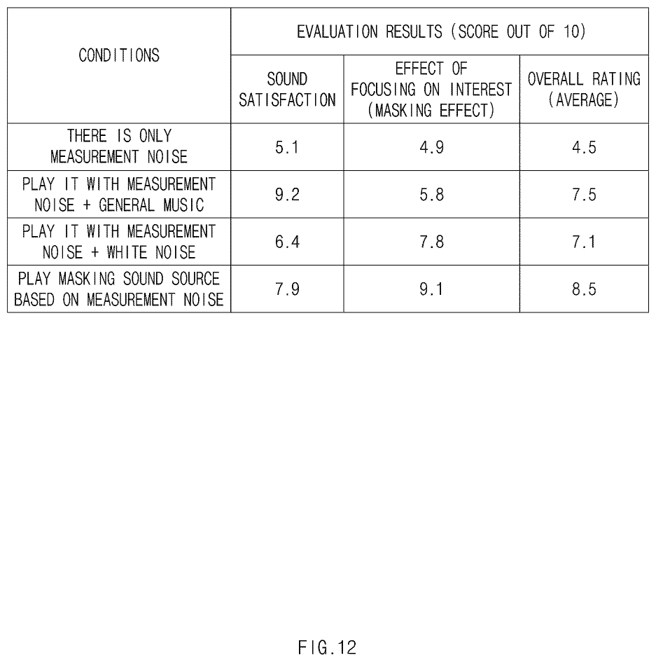

FIG. 12 illustrates an evaluation result describing an action effect according to embodiments of the present disclosure.

Referring to FIG. 12, when a masking sound source is generated and masked using the measured conversation noise, it may be identified that both sound satisfaction and the effect of focusing on the passenger's own interest in the overall rating are excellent when there is only noise, when it is masked with general music, or when it is masked with white noise.

Embodiments of the present disclosure may measure conversation noise generated in the vehicle and may generate a masking sound source using the measured conversation noise. As a result, the embodiments may generate a masking sound source similar to the timbre and magnitude of current conversation noise.

Furthermore, embodiments of the present disclosure may mask conversation noise currently generated in the vehicle using a masking sound source based on conversation noise, thus improving a masking effect.

Furthermore, embodiments of the present disclosure may mask conversation noise such that another passenger is unable to listen to conversation contents when a passenger is talking on the phone in the vehicle or is having a conversation with a specific passenger in the vehicle. As a result, the embodiments may improve conversation concentration and ensure privacy.

Hereinabove, although the present disclosure has been described with reference to various embodiments and the accompanying drawings, the present disclosure is not limited thereto. The embodiments of the present disclosure may be variously modified and altered by those having ordinary skill in the art to which the present disclosure pertains without departing from the spirit and scope of the present disclosure claimed in the following claims. Therefore, the embodiments of the present disclosure are not intended to limit the technical spirit of the present disclosure but are instead provided for illustrative purpose. The scope of the present disclosure should be construed based on the accompanying claims, and all the technical ideas within the scope equivalent to the claims should be included in the scope of the present disclosure.

What is claimed is:

1. A sound masking apparatus, comprising:
a microphone in a vehicle; and
a processor connected to the microphone,
wherein the processor is configured to
detect conversation noise using the microphone,
modulate the conversation noise to generate a masking sound source, and
mask the conversation noise by playing the masking sound source.

2. The sound masking apparatus of claim 1, wherein the processor is configured to:
determine whether a sound pressure level of a sound detected by the microphone is greater than a predetermined reference level and continues for a predetermined reference time or more;
determine that noise is generated, when it is determined that the sound pressure level of the detected sound is greater than the predetermined reference level and continues for the predetermined reference time or more;
extract a frequency characteristic from the detected sound; and
determine whether noise generated based on the extracted frequency characteristic is conversational noise.

3. The sound masking apparatus of claim 2, wherein the processor is configured to:
extract a Mel-frequency cepstral coefficient (MFCC) from the detected sound by a short-time fast Fourier transform (FFT) analysis; and
convert the extracted MFCC into a noise spectrum.

4. The sound masking apparatus of claim 1, wherein the processor is configured to modulate the conversation noise in a reverse playback scheme to generate the masking sound source.

5. The sound masking apparatus of claim 1, wherein the processor is configured to modulate the conversation noise in a reordering scheme to generate the masking sound source.

6. The sound masking apparatus of claim 1, wherein the processor is configured to:
modulate the conversation noise in a reverse playback scheme;
modulate the conversation noise in a reordering scheme; and
overlap the conversation noise modulated in the reverse playback scheme with the conversation noise modulated in the reordering scheme to generate the masking sound source.

7. The sound masking apparatus of claim 1, wherein the processor is configured to adjust a volume of the masking sound source with regard to a level of the conversation noise.

8. The sound masking apparatus of claim 1, wherein the processor is configured to:
capture an image of a passenger using a camera; and
determine a position where the conversation noise is generated, based on at least one of a mouth shape of the passenger in the captured image, whether the passenger uses a portable terminal, or any combination thereof.

9. The sound masking apparatus of claim 1, wherein the processor is configured to:
detect a sound using a microphone for each seat; and
determine a position where the conversation noise is generated, based on a level of the sound detected by the microphone for each seat.

10. The sound masking apparatus of claim 1, wherein the processor is configured to determine at least one speaker to output the masking sound source among a plurality of speakers mounted in the vehicle based on a position where the conversation noise is generated.

11. A sound masking method, comprising:
detecting conversation noise generated in a vehicle using a microphone;
modulating the conversation noise to generate a masking sound source; and
masking the conversation noise by playing the masking sound source.

12. The sound masking method of claim 11, wherein detecting the conversation noise includes:
determining whether a sound pressure level of a sound detected by the microphone is greater than a predetermined reference level and continues for a predetermined reference time or more;
determining that noise is generated, when it is determined that the sound pressure level of the detected sound is greater than the predetermined reference level and continues for the predetermined reference time or more;
extracting a frequency characteristic of the detected sound; and
determining whether noise generated based on the extracted frequency characteristic is conversational noise.

13. The sound masking method of claim 12, wherein extracting the frequency characteristic includes:
extracting a Mel-frequency cepstral coefficient (MFCC) from the detected sound by a short-time FFT analysis; and
converting the extracted MFCC into a noise spectrum.

14. The sound masking method of claim 11, wherein generating the masking sound source includes:
modulating the conversation noise in a reverse playback scheme to generate the masking sound source.

15. The sound masking method of claim 11, wherein generating the masking sound source includes:
modulating the conversation noise in a reordering scheme to generate the masking sound source.

16. The sound masking method of claim 11, wherein generating the masking sound source includes:
modulating the conversation noise in a reverse playback scheme;
modulating the conversation noise in a reordering scheme; and
overlapping the conversation noise modulated in the reverse playback scheme with the conversation noise modulated in the reordering scheme to generate the masking sound source.

17. The sound masking method of claim 11, wherein masking the conversation noise includes:
adjusting a volume of the masking sound source with regard to a level of the conversation noise.

18. The sound masking method of claim 11, wherein masking the conversation noise includes:
capturing an image of a passenger using a camera; and
determining a position where the conversation noise is generated, based on at least one of a mouth shape of the passenger in the captured image, whether the passenger uses a portable terminal, or any combination thereof.

19. The sound masking method of claim 11, wherein masking the conversation noise includes:
detecting a sound using a microphone for each seat; and
determining a position where the conversation noise is generated, based on a level of the sound detected by the microphone for each seat.

20. The sound masking method of claim 11, wherein masking the conversation noise includes:
determining at least one speaker to output the masking sound source among a plurality of speakers mounted in the vehicle based on a position where the conversation noise is generated.
